(19) United States
(12) Patent Application Publication
(10) Pub. No.: US 2012/0012738 A1
(43) Pub. Date: Jan. 19, 2012

(54) MULTIPLE WAVELENGTH RECEIVER MODULE

(75) Inventors: Takuro Shinada, Tokyo (JP); Tatsuo Hatta, Tokyo (JP); Keita Mochizuki, Tokyo (JP)

(73) Assignee: MITSUBISHI ELECTRIC CORPORATION, Tokyo (JP)

(21) Appl. No.: 13/091,174

(22) Filed: Apr. 21, 2011

(30) Foreign Application Priority Data
Jul. 14, 2010 (JP) 2010-160015

(51) Int. Cl. G01J 3/18; G01J 3/50

(52) U.S. Cl. 250/226

(57) ABSTRACT

A multiple wavelength light detector module includes an optical fiber emitting an optical signal including light of multiple wavelengths, a prism on which the optical signal is incident, a total reflection mirror bonded to a first surface of the prism, a bandpass filter bonded to a second surface of the prism, opposite the first surface, and a photodetector for detecting optical beams exiting the bandpass filter. The first surface extends at an angle with respect to the second surface. When light is incident on the bandpass filter, the bandpass filter transmits only light of a particular wavelength determined by the angle of incidence of the light, and reflects light of remaining wavelengths in the light.

### BACKGROUND OF THE INVENTION

1. Field of the Invention

The present invention relates to a multiple wavelength receiver module adapted to receive an optical signal including light of a plurality of wavelengths.

2. Background Art

Japanese Laid-Open patent Publication No. 2004-85860 discloses a multiple wavelength receiver module adapted to receive an optical signal including light of a plurality of wavelengths (which signal is referred to as a multiplexed optical signal). In this module, the received optical signal is separated, or demultiplexed, into optical beams (or optical signals) each having a different one of the wavelengths, which beams are then received by photodetectors. The module includes a plurality of filters for such demultiplexing of the multiplexed optical signal. Each filter is adapted to allow only light of a particular different wavelength to pass therethrough. That is, there are as many filters as there are wavelengths in the multiplexed optical signal.

The multiple wavelength receiver module further includes, on the exit side of the filters, condenser lenses for converting the separated optical beams into focused beams. Each condenser lens is associated with a different one of the separated optical beams. Therefore, there must be at least as many condenser lenses as there are separated optical beams. The multiple wavelength receiver module further includes, on the exit side of the condenser lenses, photodetectors for receiving or detecting the optical beams emerging from the condenser lenses. When this multiple wavelength receiver module, constructed as described above, is assembled, the optical axes of the condenser lenses and the photodetectors are adjusted (that is, aligned with each other) to reduce the optical loss in the module. This adjustment is referred to as “optical axis alignment.”

In the multiple wavelength receiver module disclosed in the above publication, each, filter and each condenser lens are adapted to handle a different one of the wavelengths in the multiplexed optical signal. This means that the more wavelengths in the multiplexed optical signal, the more filters and condenser lenses required, and hence the higher the cost of the multiple wavelength receiver module.

Further, multiple wavelength receiver modules with a plurality of condenser lens, such as the multiple wavelength receiver module disclosed in the above publication, require complicated assembly operation, since the optical axis of each condenser lens must be aligned separately.

### SUMMARY OF THE INVENTION

The present invention has been made to solve the above problems. It is, therefore, an object of the present invention to provide a low-cost multiple wavelength receiver module which is easy to assemble.

According to one aspect of the present invention, a multiple wavelength receiver module includes an optical fiber for emitting an optical signal including light of a plurality of wavelengths, a prism disposed to receive the optical signal, a total reflection mirror bonded to a first surface of the prism, a bandpass filter bonded to a second surface of the prism opposite the first surface, and a photodetector for receiving optical beams exiting the bandpass filter. The first surface extends at an angle with respect to the second surface. When light is incident on the bandpass filter, the bandpass filter transmits only light of a particular wavelength determined by the angle of incidence of the incident light, and reflects light of the remaining wavelengths in the incident light.

Other and further objects, features and advantages of the invention will appear more fully from the following description.

### BRIEF DESCRIPTION OF THE DRAWINGS

FIG. 1 a cross-sectional view of a multiple wavelength receiver module in accordance with a first embodiment of the present invention;

FIG. 2 is an enlarged view of the three-layer filter;

FIG. 3 is a diagram showing the light receiving surface of the photodetector array;

FIG. 4 is a cross-sectional view of the multiple wavelength receiver module, showing the internal light paths;

FIG. 5 is a diagram showing the light paths within the prism;

FIG. 6 is a diagram showing the paths traveled by these beams from the bandpass filter to the light receiving portions of the photodetectors;

FIG. 7 is a variation of the photodetector array of the first embodiment;

FIG. 8 is a diagram showing a variation of the total reflection mirror of the first embodiment;

FIG. 9 is a diagram showing the light receiving surface of the photodetector array of the multiple wavelength receiver module of the second embodiment;

FIG. 10 is a diagram showing a variation of the photodetector array; and

FIG. 11 is a diagram showing a multiple wavelength receiver module in accordance with a third embodiment of the present invention.

### DETAILED DESCRIPTION OF THE PREFERRED EMBODIMENTS

### First Embodiment

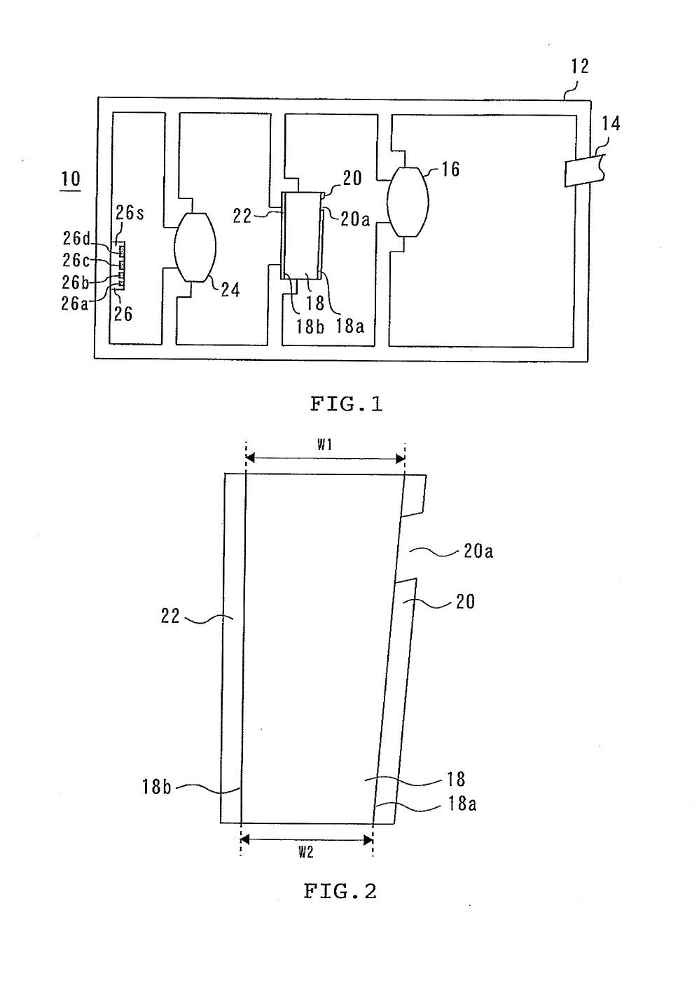

FIG. 1 is a cross-sectional view of a multiple wavelength receiver module 10 in accordance with a first embodiment of the present invention. The multiple wavelength receiver module 10 includes a holder 12. Components of the multiple wavelength receiver module 10 are secured to the holder 12. Specifically, an optical fiber 14 is fixed to the holder 12. A multiplexed optical signal is introduced into the holder 12 through the optical fiber 14. A collimator lens 16 is secured to the holder 12 on the exit side of the optical fiber 14. The collimator lens 16 is used to collimate the multiplexed optical signal.

A prism 18 is secured to the holder 12 on the exit side of the collimator lens 16. The prism 18 has a first surface 18a and an opposing second surface 18b. A total reflection mirror 20 is bonded to the first surface 18a. The total reflection mirror 20 reflects light at all the wavelengths. The total reflection mirror 20 has an opening 20a. The opening 20a is disposed to introduce the collimated multiplexed optical signal from the collimator lens 16 into the prism 18.

A bandpass filter 22 is bonded to the second surface 18b of the prism 18. The bandpass filter 22 transmits light of a different wavelength depending on the angle of incidence. That is, when the multiplexed optical signal is incident on the bandpass filter 22 at some angle of incidence, the filter 22 transmits only light of a particular wavelength determined by that angle of incidence; and when the multiplexed optical signal is incident on the bandpass filter 22 at a different angle of incidence, the filter 22 transmits only light of a different wavelength. This characteristic of the bandpass filter 22 is referred to as the angle-of-incidence dependence of the transmission of the bandpass filter 22. It should be noted that the prism 18, the total reflection mirror 20, and the bandpass filter 22 are sometimes referred to collectively as the three-layer filter.

A condenser lens 24 is secured to the holder 12 on the exit side of the three-layer filter. The condenser lens 24 is a single-piece lens. The condenser lens 24 converts the collimated optical beams exiting the bandpass filter 22 into focused beams.

A photodetector array 26 is secured to the holder 12 on the exit side of the condenser lens 24. The photodetector array 26 includes a substrate 26s and photodetectors 26a, 26b, 26c, and 26d monolithically secured to the substrate 26s.

FIG. 2 is an enlarged view of the three-layer filter. The prism 18 has a wedge configuration. Specifically, the first surface 18a extends at an angle with respect to the second surface 18b. That is, the width W1 of the upper end of the prism 18 is greater than the width W2 of the lower end of the prism 18.

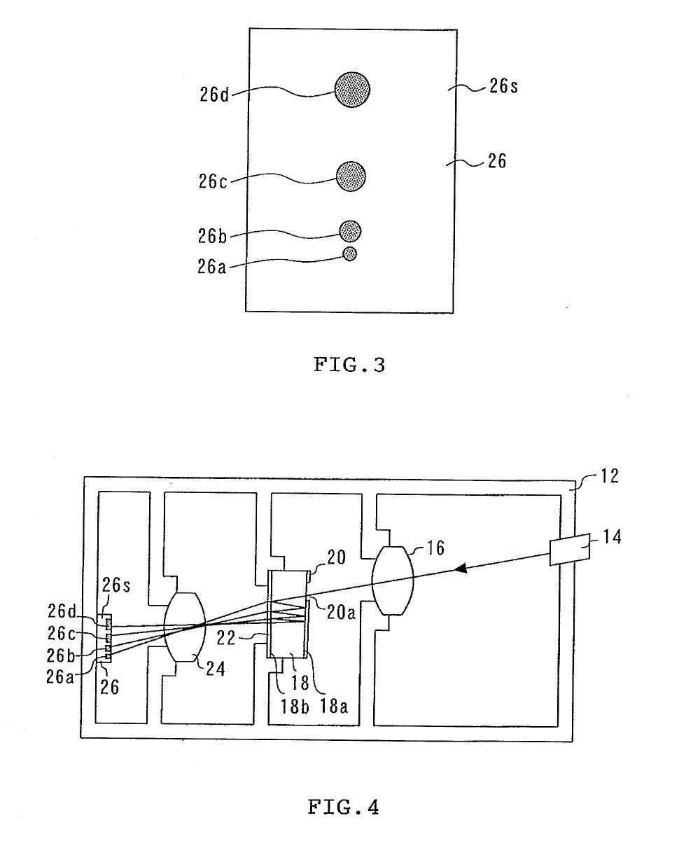

FIG. 3 is a diagram showing the light receiving surface of the photodetector array 26. The light receiving portions of the photodetectors 26a, 26b, 26c, and 26d of the photodetector array 26 increase in area in the order named (that is, the light receiving portion of the photodetector 26d is the largest in area and the light receiving portion of the photodetector 26a is the smallest). The light receiving portions of the photodetectors 26a, 26b, 26c, and 26d are linearly arranged on the substrate 26s in such a direction as to receive the separated optical beams emerging from the bandpass filter 22 at different angles.

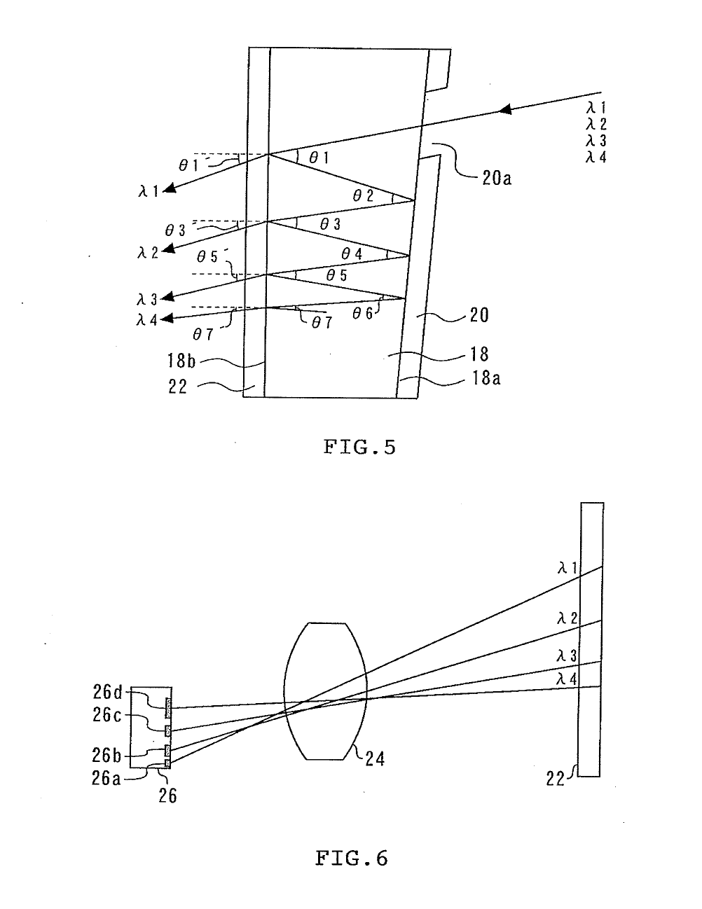

FIG. 4 is a cross-sectional view of the multiple wavelength receiver module 10, showing the internal light paths. The following description will be directed to these internal light paths. First, a multiplexed optical signal including light of wavelengths λ1, λ2, λ3, and λ4 is emitted from the optical fiber 14. This multiplexed optical signal is collimated by the collimator lens 16. The collimated optical signal is introduced into the prism 18 through the opening 20a of the total reflection mirror 20. The light paths within the prism 18 will be described with reference to FIG. 5.

FIG. 5 is a diagram showing the light paths within the prism 18. When the multiplexed optical signal is incident on the bandpass filter 22 for the first time (hereinafter referred to as the “first incidence event”), only light of wavelength λ1 in the incident light passes through the bandpass filter 22 and light of the remaining wavelengths is reflected by the bandpass filter 22 at an angle of reflection θ1 due to the angle-of-incidence dependence of the transmission of the bandpass filter 22.

The light reflected from the bandpass filter 22 at the angle of reflection θ1 is then totally reflected by the total reflection mirror 20 at an angle θ2 (hereinafter referred to as the “first total reflection event”). This totally reflected light is then incident on the bandpass filter 22 (hereinafter referred to as the “second incidence event”). The angle of incidence in the second incidence event differs from that in the first incidence event, since the incident light in the second incidence event is light totally reflected by the total reflection mirror 20, which mirror extends at an angle with respect to the bandpass filter 22. Therefore, in the second incidence event, only light of wavelength λ2 in the incident light passes through the bandpass filter 22 and light of the remaining wavelengths in the incident light is reflected by the bandpass filter 22 at an angle of reflection θ3 due to the angle-of-incidence dependence of the transmission of the bandpass filter 22.

The light reflected from the bandpass filter 22 at the angle of reflection θ3 is then totally reflected by the total reflection mirror 20 at an angle θ4 (hereinafter referred to as the “second total reflection event”). This totally reflected light is then incident on the bandpass filter 22 (hereinafter referred to as the “third incidence event”). The angle of incidence in the third incidence event differs from those in the first and second incidence events, since the incident light in the third incidence event is light totally reflected twice by the total reflection mirror 20, which mirror extends at an angle with respect to the bandpass filter 22. Therefore, in the third incidence event, only light of wavelength λ3 in the incident light passes through the bandpass filter 22 and light of the remaining wavelengths is reflected by the bandpass filter 22 at an angle of reflection θ5 due to the angle-of-incidence dependence of the transmission of the bandpass filter 22.

The light reflected from the bandpass filter 22 at the angle of reflection θ5 is then totally reflected by the total reflection mirror 20 at an angle θ6 (hereinafter referred to as the third total reflection event”). This totally reflected light is then incident on the bandpass filter 22 (hereinafter referred to as the “fourth incident event”). The angle of incidence in the fourth incidence event differs from those in the first, second, and third incidence events, since the incident light in the fourth incidence event is light totally reflected three times by the total reflection mirror 20, which mirror extends at an angle with respect to the bandpass filter 22. Therefore, in the fourth incidence event, light of wavelength λ4 in the incident light passes through the bandpass filter 22 due to the angle-of-incidence dependence of the transmission of the bandpass filter 22.

In this way the multiplexed optical signal including light of four wavelengths (namely, wavelengths λ1, λ2, λ3, and λ4) is separated, or demultiplexed, into four optical beams having wavelengths λ1, λ2, λ3, and λ4, respectively. In FIG. 5, the reference symbols λ1, λ2, λ3, and λ4 denote the separated optical beams, and θ1′, θ3′, θ5′, and θ7′ denote the exit angles of these separated optical beams λ1, λ2, λ3, and λ4, respectively, from the bandpass filter 22. Thus, the incident light entering the prism 18 travels from the wide upper side toward the narrow lower side of the prism 18 while being reflected back and forth between the bandpass filter 22 and the total reflection mirror 20. As a result, the angles of reflection θ1, θ3, θ5, and θ7 are related to one another as follows: θ1>θ3>θ5> and θ7. Further, the exit angles θ1′, θ3′, θ5′, and θ7′ described above are related to one another as follows: θ1′>θ3′>θ5′>θ7′. It should be noted that since the multiplexed optical signal includes only four wavelengths λ1, λ2, λ3, and λ4, no light is reflected from the bandpass filter 22 in the fourth incidence event (that is, no light is reflected from the bandpass filter 22 at the angle of reflection θ7).

The separated optical beams exiting the bandpass filter 22 then travel in the manner described below with reference to FIG. 6. FIG. 6 is a diagram showing the paths traveled by these beams from the bandpass filter 22 to the light receiving portions of the photodetectors. As described above, the exit angles of the separated optical beams from the bandpass filter 22 are related to one another as follows: θ1′>θ3′>θ5′>θ7′. Therefore, these optical beams cross one another at intermediate locations between the bandpass filter 22 and the photodetector array 26. The condenser lens 24 is disposed so that these intermediate locations are located within the lens 24. With this arrangement, the condenser lens 24 focuses the separated optical beams exiting the bandpass filter 22 (i.e., the four collimated optical beams having wavelengths λ1, λ2, λ3, and λ4, respectively) into focused beams. The focused beam having wavelength λ1 is then incident on the light receiving portion of the photodetector 26a, and those having wavelengths λ2, λ3, and λ4 are incident on the light receiving portions of the photodetectors 26b, 26c, and 26d, respectively.

As described above, the light receiving portions of the photodetectors 26a, 26b, 26c, and 26d increase in area in the order named (that is, the light receiving portion of the photodetector 26d is the largest in area and the light receiving portion of the photodetector 26a is the smallest). The photodetector 26d receives the optical beam (λ4) which has been reflected three times by the total reflection mirror 20; the photodetector 26c receives the optical beam (λ3) which has been reflected twice by the total reflection mirror 20; the photodetector 26b receives the optical beam (λ2) which has been reflected once by the total reflection mirror 20; and the photodetector 26a receives the optical beam (λ1) which has not been reflected by the total reflection mirror 20. Thus, photodetectors having a light receiving portion of larger area receive an optical beam which has been reflected more times by the total reflection mirror 20 and hence has traveled a longer optical path.

The construction of the multiple wavelength receiver module of the first embodiment allows a single three-layer filter to separate a multiplexed optical signal into individual optical beams. Specifically, this is accomplished by use of the bandpass filter 22 having angle-of-incidence dependent transmission characteristics and the total reflection mirror 20 adapted to reflect back light from the bandpass filter 22 so that the angle of incidence of the light to the bandpass filter 22 changes with each successive incidence. Further, the condenser lens 24 is disposed where the separated optical beams cross one another, eliminating the need for additional condenser lenses. Thus the construction of the multiple wavelength receiver module 10 of the first embodiment enables the manufacture of multiple wavelength receiver modules without using many filters and condenser lenses, and hence at low cost. Further, these multiple wavelength receiver modules are easy to assemble, since they require alignment of the optical axis of only one condenser lens.

The locations where the separated optical beams emerging from the bandpass filter 22 cross one another can be adjusted as desired by changing the exit angles of these beams from the filter 22. Changing the exit angles can be accomplished by adjusting the thickness of the prism 18, the angle of the first surface 18a with respect to the second surface 18b, and/or the angle of incidence of the multiplexed optical signal incident on the prism 18. Therefore, the condenser lens may be fixed at such a location that the module can be easily assembled. With this arrangement, the locations where the separated optical beams cross one another may be selected to be within the condenser lens 24.

The photodetectors 26a, 26b, 26c, and 26d are monolithically mounted in the photodetector array 26. Therefore, the optical axes of these photodetectors can be aligned at once.

Incidentally, there may be a variation in the angle of the multiplexed optical signal entering the prism 18 from the optical fiber 14, depending on the usage of the multiple wavelength receiver module. This results in displacement of the points of incidence of the separated optical beams on the photodetectors. The amounts of displacement, Δ26a, Δ26b, Δ26c, and Δ26d, of the points of incidence of the optical beams on the photodetectors 26a, 26b, 26c, and 26d, respectively, are related to one another as follows: Δ26a<Δ26b<Δ26c<Δ26d. That is, optical beams which have traveled a longer path are displaced in their point of incidence by a greater amount. If this amount of displacement is too great, then the photodetector cannot receive the optical beam, or there is a reduction in the optical coupling efficiency.

On the other hand, the construction of the multiple wavelength receiver module of the first embodiment ensures that the photodetectors receive the optical beams emerging from the condenser lens 24 even if there is a variation in the angle of the multiplexed optical signal entering the prism 18. Specifically, in the first embodiment, the light receiving portions of the photodetectors 26a, 26b, 26c, and 26d increase in area in the order named (that is, the light receiving portion of the photodetector 26d is the largest in area and the light receiving portion of the photodetector 26a is the smallest). That is, light receiving portions of larger area receive an optical beam displaced in its point of incidence by a greater amount. Therefore, the multiple wavelength receiver module has a high tolerance for variation in the angle of incidence of the multiplexed optical signal to the prism 18, so that the photodetectors can reliably detect the optical beams emerging from the condenser lens 24, and so that the multiple wavelength receiver module is easy to assemble.

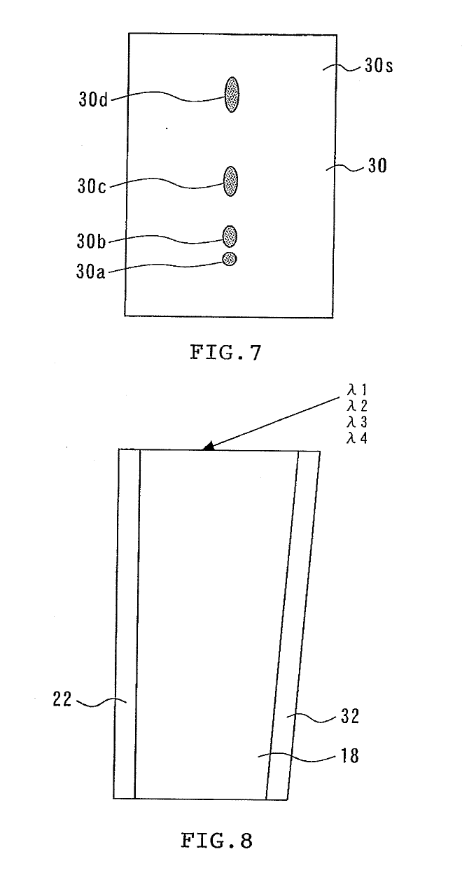

FIG. 7 is a variation of the photodetector array of the present embodiment. This photodetector array 30 differs from the photodetector array shown in FIG. 3 in that photodetectors 30a, 30b, 30c, and 30d are substituted for the photodetectors 26a, 26b, 26c, and 26d. The light receiving portions of the photodetectors 30b, 30c, and 30d are elliptical in shape, and their major axes extend in the direction in which these light receiving portions are aligned. This configuration of the photodetector array 30 is intended to accommodate displacement of the points of incidence of the optical beams on the light receiving portions of the photodetectors in a direction parallel to the direction in which the light receiving portions are aligned. Since the light receiving portions of the photodetectors 30b, 30c, and 30d are elliptical in shape and their major axes extend in the direction in which these light receiving portions are aligned, the photodetectors can reliably detect the optical beams emerging from the condenser lens 24 even if the points of incidence of the optical beams on the light receiving portions are displaced in the direction in which the light receiving portions are aligned. As a result, the multiple wavelength receiver module has a high tolerance for variation in the angle of incidence of the multiplexed optical signal to the prism 18, and furthermore the elliptical light receiving portions of the photodetectors 30b, 30c, and 30d can be made smaller in area than the circular light receiving portions of the photodetectors 26b, 26c, and 26d, respectively, of the present embodiment. Therefore in this way the areas of the light receiving portions of the photodetectors may be reduced to reduce the capacitances of the photodetectors and thereby ensure that the multiple wavelength receiver module has high speed response.

Although in the first embodiment the multiplexed optical signal emitted from the optical fiber 14 includes light of 4 wavelengths, it is to be understood that the multiplexed optical signal may include more or less than 4 wavelengths and the multiple wavelength receiver module may include as many photodetectors as there are wavelengths in the optical signal (or may include any suitable number of photodetectors). Such constructions also have the advantages described above in connection with the invention.

FIG. 8 is a diagram showing a variation of the total reflection mirror of the first embodiment. The total reflection mirror 32 shown in FIG. 8 is a single-piece mirror with no openings therein. In this case, the multiplexed optical signal is introduced into the prism 18 through its wide upper end. This eliminates the need to form an opening in the total reflection mirror 32, resulting in reduced cost of the multiple wavelength receiver module.

### Second Embodiment

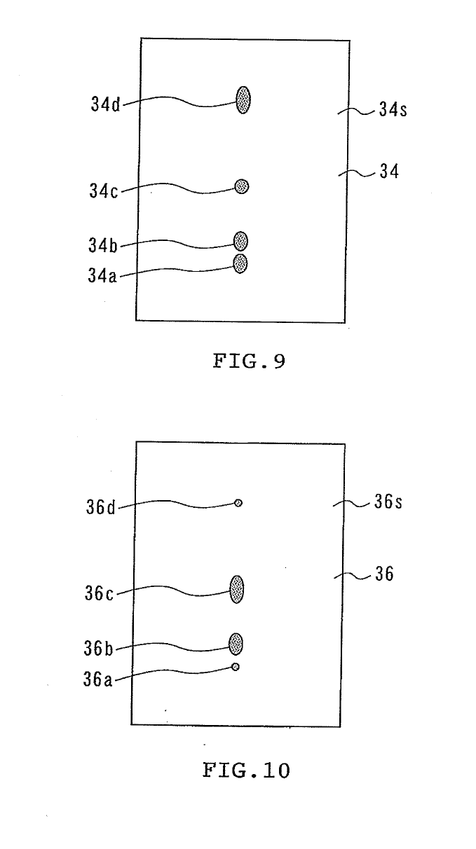

A multiple wavelength receiver module in accordance with a second embodiment of the present invention has many common features with the multiple wavelength receiver module of the first embodiment. Therefore, the following description of the multiple wavelength receiver module of the second embodiment will be directed only to the differences from the multiple wavelength receiver module of the first embodiment. FIG. 9 is a diagram showing the light receiving surface of the photodetector array 34 of the multiple wavelength receiver module of the second embodiment. The photodetector array 34 includes a substrate 34s and photodetectors 34a, 34b, 34c, and 34d monolithically mounted on the substrate 34s. The light receiving portion of the photodetector 34c is circular in shape. The light receiving portions of the photodetectors 34a, 34b, and 34d, on the other hand, are elliptical in shape and their major axes extend in the direction in which these light receiving portions are aligned. The light receiving portion of the photodetector 34c is smaller in area than the light receiving portions of the photodetectors 34a, 34b, and 34d. The adjustment of the optical axes of all photodetectors is accomplished by adjusting the optical axis of the light receiving portion of the photodetector 34c.

As described above, a variation in the angle of the multiplexed optical signal entering the prism 18 may result in displacement of the points of incidence of the optical beams on the light receiving portions of the photodetectors. In such cases, light receiving portions closer to the adjusted optical axis receive an optical beam displaced in its point of incidence by a smaller amount. The optical axis of the entire photodetector array 34 is adjusted by adjusting the optical axis of the light receiving portion of the photodetector 34c (as described above), which portion is an intermediate one of the light receiving portions linearly arranged on the substrate 34s. This means that the light receiving portions of the photodetectors of the photodetector array 34 are spaced a relatively close distance from the adjusted optical axis of the photodetector array 34 (which axis coincides with the optical axis of the light receiving portion of the photodetector 34c), resulting in reduced displacement of the point of incidence of the optical beam to each light receiving portion.

Further, the light receiving portion of the photodetector 34c is smaller in area than the light receiving portions of the other photodetectors. This makes it difficult to align the optical axis of the condenser lens 24 with the light receiving portion of the photodetector 34c. However, the alignment of the optical axis of the condenser lens 24 with the light receiving portions of all photodetectors can be accomplished by aligning the optical axis with the light receiving portion of the photodetector 34c alone. Thus, the light receiving portion of one of the photodetectors may be made smaller in area than the light receiving portions of the other photodetectors, and the optical axis of the condenser lens 24 may be aligned with this light receiving portion to facilitate the assembly operation (axis alignment operation) of the multiple wavelength receiver module.

FIG. 10 is a diagram showing a variation of the photodetector array 34. This photodetector array 36 is characterized by the configurations of the light receiving portions of its photodetectors 36a, 36b, 36c, and 36d. Specifically, the light receiving portions of the uppermost photodetector 36d and the lowermost photodetector 36a are smaller in area than the light receiving portions of the other photodetectors. With this arrangement, the alignment of the optical axis of the condenser lens 24 with the light receiving portions of all photodetectors can be accomplished only by aligning the optical axis with the light receiving portions of the photodetectors 36a and 36d, since the light receiving portions of the photodetectors 36b and 36c are larger in area than the light receiving portions of the photodetectors 36a and 36d. This facilitates the assembly operation (axis alignment operation) of the multiple wavelength receiver module.

### Third Embodiment

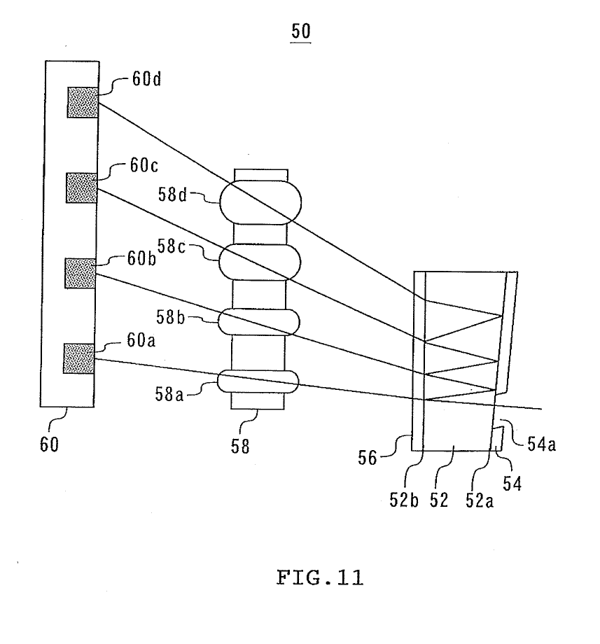

FIG. 11 is a diagram showing a multiple wavelength receiver module 50 in accordance with a third embodiment of the present invention. This multiple wavelength receiver module 50 includes a prism 52. A total reflection mirror 54 is bonded to a first surface 52a of the prism 52. The total reflection mirror 54 has an opening 54a. A bandpass filter 56 is bonded to a second surface 52b of the prism 52 opposite the first surface 52a. The first surface 52a extends at an angle with respect to the second surface 52b; that is, the upper end of the prism 52 has a greater width than the lower end of the prism 52. The prism 52, the total reflection mirror 54, and the bandpass filter 56 are herein referred to collectively as the three-layer filter.

A condenser lens array 58 is formed on the exit side of the three-layer filter. The condenser lens array 58 includes monolithically formed condenser lenses 58a, 58b, 58c, and 58d.

A photodetector array 60 is formed on the exit side of the condenser lens array 58. The photodetector array 60 includes monolithically formed photodetectors 60a, 60b, 60c, and 60d.

The propagation of light within the multiple wavelength receiver module 50 thus constructed will be described. First, a multiplexed optical signal is introduced into the prism 52 through the opening 54a. That is, the multiplexed optical signal enters into the narrow lower portion of the prism 52. The multiplexed optical signal introduced into the prism 52 is separated, or demultiplexed, into four individual optical beams in the same manner as described above in connection with the first embodiment. Therefore, this separation process will not be described herein. The four separated optical beams are then incident on the condenser lenses 58a, 58b, 58c, and 58d, respectively. The optical beams exiting the condenser lenses 58a, 58b, 58c, and 58d are then incident on the photodetectors 60a, 60b, 60c, and 60d, respectively.

An application or specifications of a multiple wavelength receiver module may require that the photodetectors be spaced a certain distance from one another. In such cases, there is no way to cause the optical beams emerging from the three-layer filter to cross one another before they are incident on their respective photodetectors, making it necessary to provide a condenser lens for each of the separated optical beams. Mounting a plurality of discrete condenser lenses in a multiple wavelength receiver module complicates the assembly of the module. The multiple wavelength receiver module of the third embodiment avoids this problem by having a condenser lens array including a plurality of condenser lenses, instead of having a plurality of discrete condenser lenses. This array of condenser lenses can be mounted at once, resulting in simplified assembly of the module.

Thus the present invention enables the manufacture of low-cost multiple wavelength receiver modules which are easy to assemble.

Obviously many modifications and variations of the present invention are possible in the light of the above teachings. It is therefore to be understood that within the scope of the appended claims the invention may be practiced otherwise than as specifically described.

The entire disclosure of a Japanese Patent Application No. 2010-160015, filed on Jun. 14, 2010 including specification, claims, drawings and summary, on which the Convention priority of the present application is based, are incorporated herein by reference in its entirety.

1. A multiple wavelength light detector module comprising:
an optical fiber for emitting an optical signal including light of a plurality of wavelengths;
a prism on which the optical signal is incident;
a total reflection mirror bonded to a first surface of said prism;
a bandpass filter bonded to a second surface of said prism, said second surface being opposite said first surface; and
a photodetector for detecting optical beams exiting said bandpass filter, wherein
said first surface extends at an angle with respect to said second surface, and
when light is incident on said bandpass filter, said bandpass filter transmits only light of a particular wavelength determined by angle of incidence of the light that is incident on said bandpass filter, and reflects light of other wavelengths in the light that is incident on the bandpass filter.

2. The multiple wavelength light detector module according to claim 1, further comprising a condenser lens disposed where the optical beams exiting said bandpass filter cross one another.

3. The multiple wavelength light detector module according to claim 1, further comprising a plurality of said photodetectors on a single substrate.

4. The multiple wavelength light detector module according to claim 3, wherein:
light detecting portions of said plurality of photodetectors are linearly aligned on said substrate in a direction to detect the optical beams exiting said bandpass filter at different angles, the optical beams having been demultiplexed from the optical signal by said bandpass filter; and
at least one of said light detecting portions is elliptical in shape, and has a major axis extending in the direction in which said light detecting portions are aligned on said substrate.

5. The multiple wavelength light detector module according to claim 3, wherein:
light detecting portions of said plurality of photodetectors are linearly arranged on said substrate in a direction to detect the optical beams exiting said bandpass filter at different angles, the optical beams having been demultiplexed from the optical signal by said bandpass filter; and
an intermediate one of said light detecting portions linearly arranged on said substrate is smaller in area than all other of said light detecting portions.

6. The multiple wavelength light detector module according to claim 3, wherein:
light detecting portions of said plurality of photodetectors are linearly arranged on said substrate in a direction to detect the optical beams exiting said bandpass filter at different angles, the optical beams having been demultiplexed from the optical signal by said bandpass filter; and
the two outermost light detecting portions of said light detecting portions linearly arranged on said substrate are smaller in area than all other of said light detecting portions.

7. The multiple wavelength light detector module according to claim 3, wherein the light detecting portions of said plurality of photodetectors have differing areas and said light detecting portions having larger areas detect optical beams which travel a longer path to said light detecting portions than the optical beams detected by said light detecting portions having smaller areas.

8. The multiple wavelength light detector module according to claim 3, wherein one of said light detecting portions of said plurality of photodetectors is smaller in area than all other of said light detecting portions.

9. The multiple wavelength light detector module according to claim 3, comprising a condenser lens array disposed between said bandpass filter and said plurality of photodetectors, said condenser lens array including a plurality of condenser lenses on a substrate.
